(19) United States
(12) Patent Application Publication
(10) Pub. No.: US 2009/0196667 A1
(43) Pub. Date: Aug. 6, 2009

(54) Printing System for Printing Banner Media And Method Thereof

(76) Inventors: Aaron Don Deckard, Lexington, KY (US); Benjamin Charles De Vore, Lexington, KY (US); Glen Alan Reidhaar, Lexington, KY (US); Kevin Dean Schoedinger, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/026,074

(22) Filed: Feb. 5, 2008

(51) Int. Cl. G03G 15/00

(52) U.S. Cl. 399/364

(57) ABSTRACT

A printing system for duplex printing of a banner media is disclosed. The printing system includes a drive roll, a pair of nipping rolls abuttingly coupled to the drive roll forming a first nip and a second nip with the drive roll, a media path including a printing region and a duplex region, and a diverter disposed in the media path and coupled to the drive roll. A first side of the banner media is printed in the printing region and exited partially from the first nip. Further, the partially exited banner media is re-fed into the duplex region and transferred to the printing region to print the second side of the banner media and exited from the second nip. The duplex region is capable of receiving the banner media from the first nip and the printing region is capable of exiting the banner media from the second nip simultaneously.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to image forming devices, and more particularly to printing systems for duplex printing of banner media.

2. Description of the Related Art

Presently, a lot of research is going on in designing image forming devices such as printing systems catering to printing of banner media. The banner media may be a media sheet sufficiently larger than a normal legal paper. The banner media may be used for advertising and promotional purposes for brands, exhibitions, carnival, and the like. Further, duplex printing, which is two-sided printing of the banner media, has also been a prime concern for the designers of the printing systems. Presently, there are printing systems known in the art, which are capable of performing duplex printing of a limited length media sheet, which may be equivalent to standard office paper such as a legal paper in length. Typically, these printing systems follow a procedure of printing a first side of the legal paper in a printing region of a media path and exiting the legal paper from the media path partially while retaining at least a portion of the legal paper at an exit nip with the help of drive rolls. Thereafter, the directions of rotation of the drive rolls are reversed and the legal paper is inserted back into the media path of the printing system to perform the printing on the second side of the legal paper. Further, the legal paper is exited from the exit nip into an output bin after completion of printing on both sides of the legal paper. The above printing operation may be referred to as a ‘peek-a-boo type of duplex turnaround printing’ as a portion of the legal paper is exited from the printing system and turned around by re-inserting in the printing system in order to print the other side of the legal paper.

The above described printing systems generally use a single exit for both a duplex turnaround and an exit into the output bin. FIG. 1 illustrates a schematic diagram of such a prior art printing system 100, which is capable of performing the duplex printing of a standard office paper, such as a legal paper 160. Only media path and an output section of the media path of printing system 100 are illustrated in FIG. 1. At the output section of printing system 100, there are two drive rolls 110 and 120, which are placed against each other such that drive rolls 110 and 120 form a nip 130 therebetween. Further, the media path of printing system 100 includes a printing path 140 and a duplex path 150. For duplex printing of legal paper 160 in printing system 100, initially a first side of legal paper 160 is printed in printing path 140. Further, legal paper 160 is exited from nip 130 (a leading edge 162 of legal paper 160 exits first) by correspondingly rotating drive rolls 110 and 120 in the anticlockwise and clockwise directions, respectively. Specifically, legal paper 160 is exited partially from nip 130 such that a trailing edge 164 of legal paper 160 is gripped by nip 130, while remaining portion of legal paper 160 lies outside of nip 130.

Further, directions of the rotation of drive rolls 110 and 120 are reversed and legal paper 160 starts re-feeding into duplex path 150. Printing system 100 uses a mechanism such as a diverter 166, which by changing positions ensures that during re-feeding of partially exited legal paper 160, legal paper 160 follows duplex path 150 instead of printing path 140. Legal paper 160 is further transferred to printing path 140 from duplex path 150. In printing path 140, a second side of legal paper 160 is printed. Thereafter, legal paper 160 is exited from nip 130 and collected in an output bin.

It will be obvious to persons skilled in the art that in these printing systems, such as printing system 100, nip 130, is shared for both the duplex turnaround and the exit into output bin. More specifically, nip 130 is used for exiting legal paper 160 partially from the media path of the printing system 100 and also for the re-feeding of the partially exited legal paper 160 into the duplex path 150. As a result, these printing systems are capable of only supporting a media sheet, having limited length, such as legal paper 160. This is for the reason that after the printing of the second side of legal paper 160, when leading edge 162 of legal paper 160 attempts to leave from nip 130, it is required that the re-feeding of trailing edge 164 of legal paper 160 is completed. More specifically, at a time when leading edge 162 of legal paper 160 is received by nip 130, the re-feeding of trailing edge 164 of legal paper 160 is completed and trailing edge 164 is completely received in duplex path 150. This restricts the capability of printing system 100 to duplex print a media sheet having length larger than standard office papers such as legal paper 160 due to the constraints that length of the media sheet should always be less than length of the media path in such printing systems as there is a single exit for the re-feeding of partially exited legal paper 160 into duplex path 150 and for the exiting of legal paper 160 into the output bin.

Further, there are existing printing systems that use two separate exits, one for duplex turnaround and another for exit into an output bin. However, these existing printing systems only support a media sheet of a specific length, such as an A4 media sheet, which is substantially smaller than the length of the banner media. Furthermore, there are also existing double exit printing systems that support a media sheet up to length of the banner media. Such double exit printing systems eject the banner media completely from a first exit, lift the banner media up to a second exit that performs as a duplex intake, and then pulls the banner media into a duplex path of these printing systems. Such arrangements/configurations would introduce difficulty for turning around the banner media for the re-feeding of the banner media into the duplex path.

Based on the foregoing, there is a need for a printing system that is capable of performing a duplex printing of a banner media of unlimited length without having a limitation of a media path of the printing system. Further, the printing system should also be capable of turning around the banner media for duplex printing without completely exiting the banner media from the printing system.

### SUMMARY OF THE INVENTION

In view of the foregoing disadvantages inherent in the prior art, the general purpose of the present invention is to provide a printing system and a method for duplex printing of a banner media of infinite length,(hereinafter referred to as banner media) to include all the advantages of the prior art, and to overcome the drawbacks inherent therein.

In one aspect, the present invention provides a printing system for printing a banner media on a first side of the banner media and a second side of the banner media. The printing system includes a drive roll capable of rotating in a first direction and a second direction opposite to the first direction, a pair of nipping rolls, a media path and a diverter. The pair of nipping rolls is abuttingly coupled to the drive roll and is capable of rotating in the first direction and the second direction along with a rotation of the drive roll. The pair of nipping rolls forms a first nip and a second nip with the drive roll. The media path includes a printing region and a duplex region and the diverter is placed in the media path and is operatively connected to the drive roll. During the printing of the first side of the banner media in the printing region, the diverter is moved to a first position and the drive roll is rotated in the first direction to guide the banner media through the first nip to be partially exited from the first nip. The banner media is exited partially from the first nip such that a portion of the banner media is gripped by the first nip. Further, the drive roll is configured to change its direction of rotation to a second direction and the diverter is configured to move to the second position to re-feed the partially exited banner media into the duplex region of the media path. The duplex region is configured to transfer the banner media to the printing region for the printing of the second side of the banner media. Further, the diverter remains in the second position to exit the banner media into an output media tray from the second nip. Furthermore, the duplex region of the media path is capable of receiving the partially exited banner media from the first nip and the printing region of the media path is capable of exiting the banner media from the second nip simultaneously.

In another aspect, the present invention provides a method for printing a banner media on a first side of the banner media and a second side of the banner media in a printing system. The method includes receiving the banner media in a printing region of a media path of the printing system from an input media tray. Further, printing of the first side of the banner media is performed in the printing region and the banner media, which is printed on the first side, is exited partially from a first nip of the printing system. The first nip is formed between an abutting arrangement of a drive roll and a first nipping roll, where the drive roll rotates in a first direction in order to partially exit the banner media from the first nip. Further, the method includes changing the direction of rotation of the drive roll into a second direction to allow the partially exited banner media to be received into a duplex region of the media path. The method further includes printing the second side of the banner media into the printing region upon transferring the banner media from the duplex region to the printing region. Thereafter, the banner media is exited into an output media tray through a second nip formed between the drive roll and a second nipping roll. Further, the method is capable of receiving the partially exited banner media after the printing of the first side of the banner media, in the duplex region of the media path through the first nip and exiting the banner media from the printing region through the second nip, simultaneously

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic diagram, depicting components of a prior-art printing system;

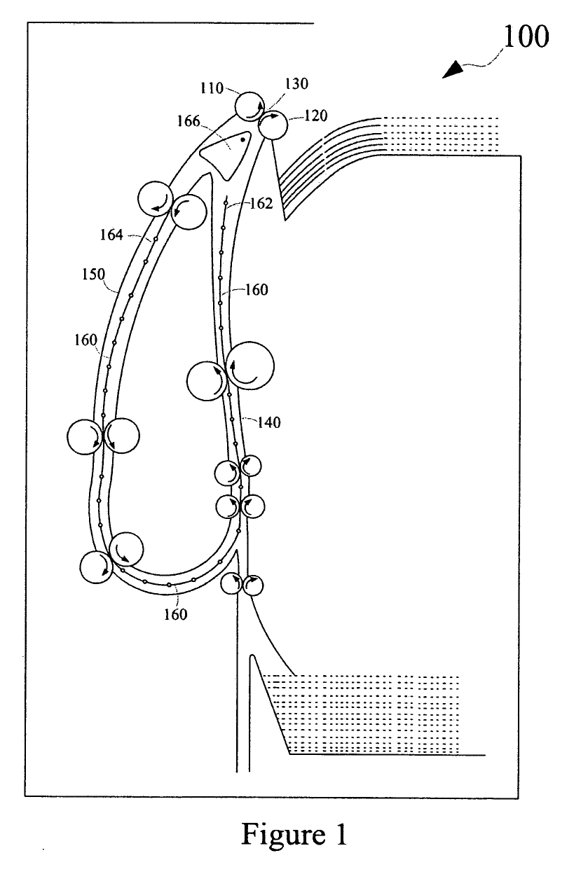

FIG. 2 is a schematic depiction of components of an exemplary printing system embodying the present invention;

FIG. 3 is a schematic depiction of printing on a first side of a banner media in an exemplary printing system embodying the present invention;

FIG. 3A is a schematic depiction of completion of the printing on the first side of the banner media and a duplex turnaround of the banner media for a printing on a second side of the banner media;

FIG. 4 is a schematic depiction of the printing on the second side of the banner media in an exemplary printing system embodying the present invention; and

FIG. 5 is a schematic depiction of completion of duplex printing of the banner media and receiving a subsequent banner media for duplex printing in an exemplary printing system embodying the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present invention provides a printing system and a method for duplex printing of a banner media on a first side of the banner media and a second side of the banner media. The term image as used herein encompasses any printed or digital form of text, graphic, or combination thereof. The term output as used herein encompasses output from any printing system such as color and black-and-white copiers, color and black-and-white printing systems, and so-called “all-in-one devices” that incorporate multiple functions such as scanning, copying, and printing capabilities in one device. Such printing systems may utilize ink jet, dot matrix, dye sublimation, laser, and any other suitable print formats.

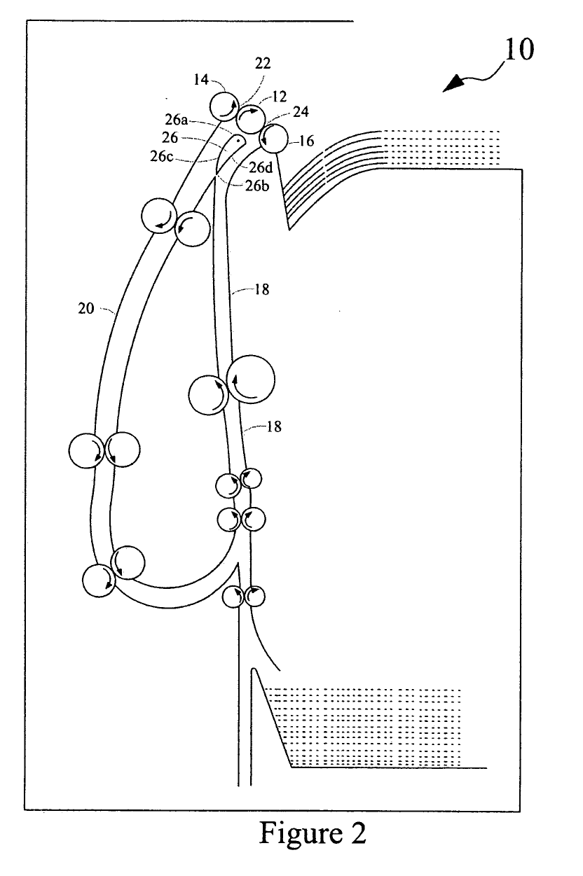

Referring now to the drawings and particularly to FIG. 2, there is shown a diagrammatic depiction of components of a printing system 10 embodying the present invention. Printing system 10 is capable of printing a banner media on both sides of the banner media. Printing system 10 includes a drive roll 12, a pair of rolls including a first nipping roll 14 and a second nipping roll 16, a media path including a printing region 18 and a duplex region 20 and a diverter 26. Drive roll 12 is capable of rotating in both a clockwise direction and an anticlockwise direction. First nipping roll 14 and second nipping roll 16 are abuttingly coupled to drive roll 12 and form a contact therebetween. An abutting adjacent placement of first nipping roll 14 and drive roll 12 forms a first nip 22. Similarly, the abutting adjacent placement of second nipping roll 16 and drive roll 12 forms a second nip 24.

The media path of printing system 10 is similar in structure of a loop ordinarily encompassing printing region 18 and duplex region 20. Printing region 18 of the media path includes printing mechanism such as an imaging section (not shown) and a fusing section (not shown) known in the art to perform the printing operation. Diverter 26 is positioned at the intersection of printing region 18 and duplex region 20 towards drive roll 12 and is coupled to drive roll 12. In an embodiment of the present invention, diverter 26 has a pivotal end 26a and a media tip 26b. Pivotal end 26a is operationally coupled to drive roll 12. In an embodiment of the present invention, diverter 26 may be of a saw tooth structure with two lateral edges such as a first media edge 26c and a second media edge 26d between pivotal end 26a and media tip 26b.

Diverter 26 is controlled to change positions by rotating around pivotal end 26a such that the banner media may be guided to one of first nip 22 and second nip 24 from printing region 18. For example, when diverter 26 is at a first position, a banner media coming from printing region 18 may be guided to first nip 22 by following first media edge 26c. Similarly, when diverter 26 is at a second position, a banner media coming from printing region 18 may be guided to second nip 24 by following second media edge 26d. Further, diverter 26 is also configured to guide a banner media to duplex region 20 from first nip 22.

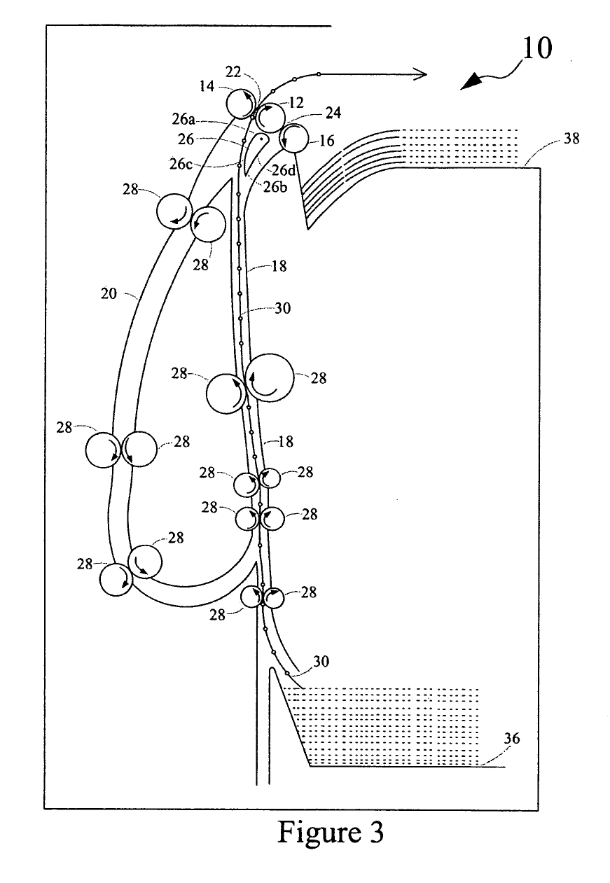

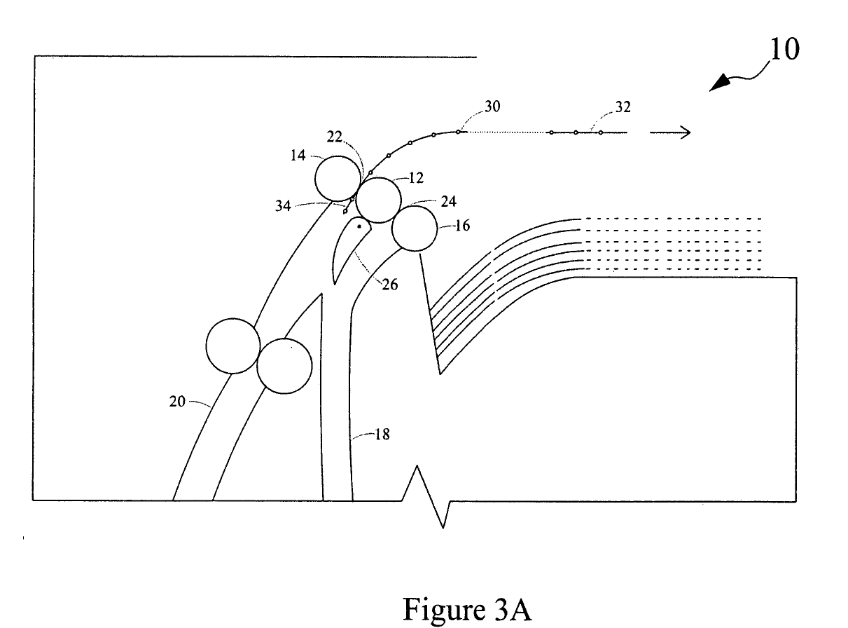

Referring now to FIGS. 3, 4 and 5, there are shown schematic depictions of printing system 10, which will be utilized to explain the configuration and working of various components of the printing system 10. Further, description of FIGS. 3, 4 and 5 also describe a method of printing on a first side and a second side of a banner media in printing system 10.

FIG. 3 is a schematic diagram of printing system 10 illustrating the printing on a first side of a banner media 30 embodying the present invention. Banner media 30 is received from an input media tray 36 for printing on the first side of the banner media 30. Input media tray 36 may be a tray, which supplies raw banner media to printing system 10 and may be configured within or outside of printing system 10. As already mentioned, banner media 30 has two printable sides including a first side and a second side. Further, banner media 30 has a first edge 32 (see FIG. 3A) and a second edge 34 (see FIG. 3A). During the printing of the first side of banner media 30, first edge 32 is a leading edge of banner media 30 that enters printing region 18.

In printing region 18, the first side of banner media 30 is printed. In one embodiment of the present invention, printing system 10 comprises media path rolls 28 disposed in the media path, which transfer banner media 30 towards drive roll 12. More specifically, a portion of banner media 30, for which printing is completed, continuously moves towards drive roll 12. At the same time, diverter 26 is positioned at the first position. It will be apparent to a person skilled in the art that initial position of diverter 26 may be at the first position at the start of the printing process of banner media 30.

Further, subsequent to the printing on the first side of banner media 30, leading edge of banner media 30, i.e., first edge 32, is guided through first nip 22 that is configured between drive roll 12 and first nipping roll 14. In an embodiment of the present invention, as represented in FIG. 3, during the printing on the first side of banner media 30, drive roll 12 rotates in the clockwise direction and first nipping roll 14 rotates in the anticlockwise direction. Accordingly, banner media 30 starts exiting from first nip 22. After the completion of the printing on the first side of banner media 30, banner media 30 is exited partially from first nip 22 such that first edge 32 of banner media 30 lies outside of first nip 22 and second edge 34 of banner media is gripped in first nip 22 as represented in FIG. 3A.

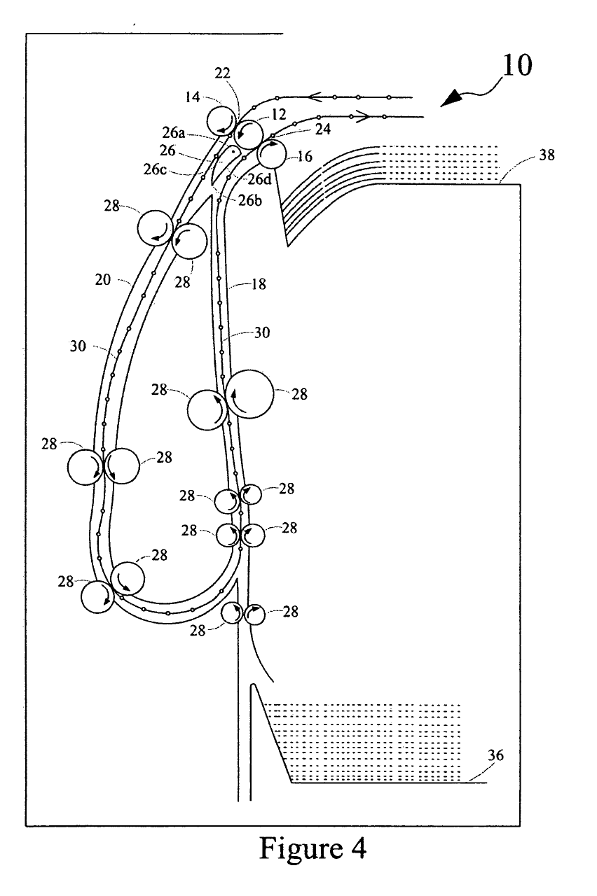

Further, referring to FIG. 4, there is shown a schematic depiction of the printing on the second side of banner media 30. After the completion of the printing on the first side of banner media 30, drive roll 12 stops rotating in the clockwise direction, as shown in FIG. 3A. Thereafter, drive roll 12 starts rotating in the anticlockwise direction. At the same time diverter 26 moves to the second position. As a result of that, trailing edge, i.e., second edge 34 of banner media 30, which is gripped in first nip 22, starts re-feeding into duplex region 20 of the media path. It will be apparent to persons skilled in the art that second edge 34 of banner media 30 now becomes a leading edge in duplex region 20 and correspondingly first edge 32 becomes a trailing edge during the printing of the second side of banner media 30.

Duplex region 20 of the media path includes media path rolls 28, which are configured to transfer banner media 30 to printing region 18. It will be apparent to persons skilled in the art that of after the re-feeding of banner media 30 in duplex region 20, banner media 30 is tuned around and the second side of banner media 30 faces the printing mechanism of printing region 18. Printing region 18 further performs the printing process on the second side of banner media 30.

Further, media path rolls 28, which are also disposed in printing region 18, continuously transfers banner media 30 towards drive roll 12. Further, during the printing on the second side of banner media 30, diverter 26 remains in the second position to guide the leading edge, i.e., now the second edge 34 of banner media 30 to be exited from second nip 24.

From FIG. 4, it will be apparent to persons skilled in the art that during the printing on the second side of banner media 30, second edge 34 of banner media 30 may be exiting from second nip 24 and first edge 32 of banner media 30 may be still entering first nip 22. More specifically, in the embodiment as represented in FIG. 4, it is evident that in printing system 10 is capable of exiting one portion of banner media 30 and receiving another portion of banner media 30 at the same time.

Persons skilled in the art would appreciate the fact that in ideal conditions, the present invention provides an option of printing a banner media of an infinite length, as duplex region 20 receives the partially exited banner media from first nip 22, and at the same time a portion of banner media 30 is also exited from second nip 24 as a completed printed part of the banner media 30 after getting printed in printing region 18.

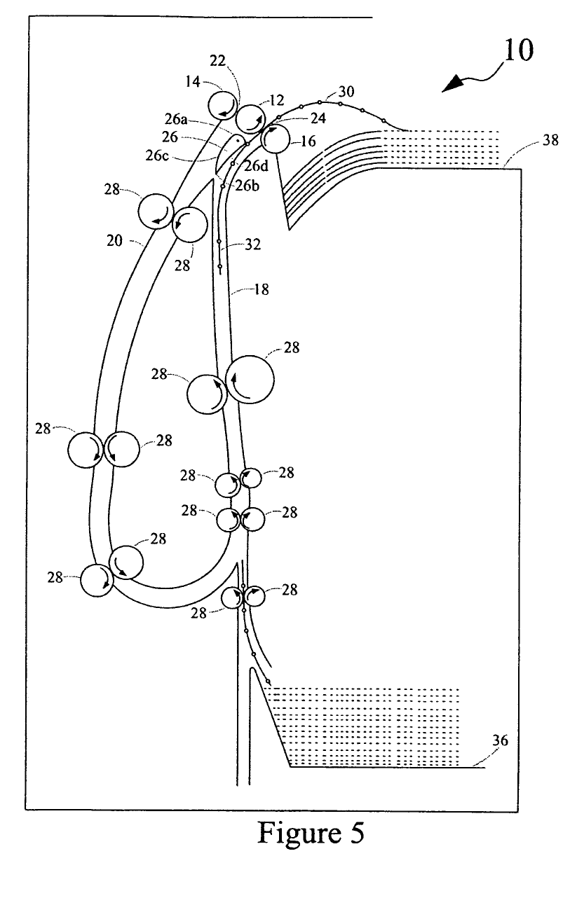

Further, referring to FIG. 5, there is shown a schematic depiction of the completion of the printing of banner media 30 and receiving a subsequent banner media. It is shown that banner media 30 leaves printing region 18 through second nip 24 to be collected in output media tray 38. It is also shown that the subsequent banner media is received from input media tray 36. Persons skilled in the art would appreciate the fact that the present invention ensures a predefined time gap maintained between exit of first edge 32 of a previous banner media, i.e., banner media 30 and entering of the subsequent banner media in printing region 18.

It will also be evident from the description of FIGS. 3, 4 and 5 to persons skilled in the art that during the printing of banner media 30, media path rolls 28 rotate in a constant direction, i.e., the direction of rotation of media path rolls 28 need not be changed. Media path rolls 28 are only configured to rotate in a direction such that banner media 30 is transferred from duplex region 20 to printing region 18 and from printing region 18 towards drive roll 12.

The foregoing description of several methods and an embodiment of the invention have been presented for purposes of illustration. It is not intended to be exhaustive or to limit the invention to the precise steps and/or forms disclosed, and obviously many modifications and variations are possible in light of the above description. It is intended that the scope of the invention be defined by the claims appended hereto.

What is claimed is:

1. A printing system for printing a banner media on a first side of the banner media and a second side of the banner media, the printing system comprising:
a drive roll capable of rotating in a first direction and a second direction opposite to the first direction;
a pair of nipping rolls, each of the pair of nipping rolls abuttingly coupled to the drive roll and capable of rotating in the first direction and the second direction corresponding to a rotation of the drive roll, a first nipping roll of the pair of nipping rolls forming a first nip between the first nipping roll and the drive roll, and a second nipping roll of the pair of nipping rolls forming a second nip between the second nipping roll and the drive roll;
a media path comprising,
a printing region capable of printing the banner media on the first side of the banner media and the second side of the banner media and transferring the banner media to the drive roll, and
a duplex region extending into the printing region, the duplex region configured to receive the banner media from the first nip and transfer the banner media to the printing region; and
a diverter disposed in the media path and operatively connected to the drive roll, the diverter capable of guiding the banner media from the printing region of the media path to one of the first nip and the second nip,
wherein the diverter is configured to move to a first position and the drive roll is configured to rotate in the first direction during the printing on the first side of the banner media to guide the banner media to be exited partially from the first nip, and wherein the diverter is configured to move to a second position and the drive roll is configured to rotate in the second direction after the printing on the first side of the banner media such that the partially exited banner media is guided into the duplex region of the media path, and
wherein the printing region is further configured to print the second side of the banner media upon receiving the banner media from the duplex region and exiting the banner media from the second nip; and
wherein the duplex region of the media path is capable of receiving the partially exited banner media from the first nip and the printing region of the media path is capable of exiting the banner media from the second nip simultaneously.

2. The printing system of claim 1 further comprising at least one media path roll disposed in each of the duplex region and the printing region of the media path, wherein the at least one media path roll in the duplex region is configured to transfer the banner media from the duplex region to the printing region, and wherein the at least one media path roll in the printing region is configured to transfer the banner media from the printing region to the drive roll.

3. The printing system of claim 1 wherein the banner media is exited partially from the first nip after the completion of the printing on the first side of the banner media such that a leading edge of the banner media lies outwardly from the first nip and a trailing edge of the banner media is gripped by the first nip.

4. The printing system of claim 1 further comprising an output media tray for collecting the banner media exited from the second nip.

5. The printing system of claim 1 wherein the diverter remains in the second position during the printing on the second side of the banner media.

6. The printing system of claim 1 further comprising an input media tray for receiving the banner media in the printing region for the printing on the first side of the banner media.

7. The printing system of claim 1 wherein the diverter is configured at an intersection of the duplex region and the printing region of the media path towards the drive roll.

8. A method for printing a banner media on a first side of the banner media and a second side of the banner media in a printing system, the method comprising:
receiving the banner media in a printing region of a media path of the printing system from an input media tray;
printing the first side of the banner media in the printing region;
exiting the banner media partially from a first nip of the printing system, the first nip formed between a drive roll and a first nipping roll abuttingly coupled to the drive roll, wherein exiting the banner media partially from the first nip comprises rotating the drive roll in a first direction;
receiving the partially exited banner media in a duplex region of the media path from the first nip by rotating the drive roll in a second direction, wherein the second direction is opposite to the first direction;
printing the second side of the banner media in the printing region of the printing system upon transferring the banner media to the printing region from the duplex region; and
exiting the banner media from a second nip, the second nip formed between the drive roll and a second nipping roll abuttingly coupled to the drive roll,
wherein exiting the banner media from a second nip comprises rotating the drive roll in the second direction; and
wherein receiving the partially exited banner media in the duplex region of the media path through the first nip and exiting the banner media from the printing region through the second nip is performed simultaneously.

9. The method of claim 8 wherein exiting the banner media partially from a first nip of the printing system comprises exiting a leading edge of the banner media from the first nip and securing a trailing edge of the banner media in the first nip.

10. The method of claim 8 further comprising collecting the banner media exited from the second nip into an output media tray.

11. The method of claim 8 wherein receiving the partially exited banner media in the duplex region of the media path from the first nip comprises changing a direction of rotation of the drive roll to the second direction from the first direction after the printing of the first side of the banner media.
